(19) United States
(12) Patent Application Publication
(10) Pub. No.: US 2012/0070285 A1
(43) Pub. Date: Mar. 22, 2012

(54) INDEPENDENT, DISTRIBUTED PROTECTION AND SAFETY SYSTEM WITH FIBER OPTIC COMMUNICATION FOR WIND TURBINES

(75) Inventor: Kevin L. Cousineau, Lompoc, CA (US)

(73) Assignee: Clipper Windpower, Inc.

(21) Appl. No.: 12/883,276

(22) Filed: Sep. 16, 2010

(51) Int. Cl. F03D 7/00

(52) U.S. Cl. 416/31

(57) ABSTRACT

A safety system and method for monitoring the safety of a windmill turbine is disclosed. A protection safety master (PSM) controller is coupled to one or more input/output modules via an optic conductor. Safety components are individually coupled to and monitored by the modules. The modules are distributed throughout a wind turbine tower and provide status information about the safety components to the PSM controller. Based on data received, the PSM controller independently determines whether a fail-safe reaction should be initiated and initiates the fail-safe reaction accordingly.

### FIELD

The present disclosure relates generally to energy producing devices. More particularly, the disclosure relates to safety systems and methods for maintaining safety for wind turbines.

### BACKGROUND

Wind turbines drive synchronous or asynchronous generators to produce electrical power with systems for feathering the turbine's blades when it is desired to shut the turbine down. A condition requiring such blade feathering is excessive wind velocity, for example, in the event of a strong storm or hurricane-type wind conditions that could cause great damage if the rotating blades are separated from the rotor by the force of the wind. To achieve such feathering, the pitch angle of the blades is adjusted to approximately 90° whereupon wind flow over the blades fails to produce any torque, which would otherwise cause rotation of the blades and, therefore, rotation of the generator connected to the rotor.

Conventional Utility Grade wind turbines, with electric pitch systems, employ stored energy systems to back up the pitch system power supply and enable the turbine to safely feather the blades in case of an emergency condition, even in the event of loss of power. Once all three blades are brought to a feathered (90 degree pitch angle) position the turbine is in no danger from a run-away condition and can handle even the highest of winds with little problems.

Additionally, each turbine must employ independent pitch motors and power supplies (such as batteries or super capacitors or other energy storage systems) for each blade in order to meet the international and certification requirements for two independent means of stopping a turbine during an emergency event. In this case there are actually three means; each blade and all turbines must demonstrate that it can come to a safe speed and position even when one of these three pitch systems fails to move the blade at all from its fine pitch setting.

FIG. 4 shows a typical electric pitch system 400 with a battery back-up 402 and an associated safety system 404, which employs the battery 402 for blade feathering with one of three axes shown. During an emergency condition the Emergency Feather Command relay K1 (414) will switch battery power to a DC motor 416 and it, in turn, will pitch the blades to their feathered position. Upon reaching that position, a feather limit switch 418 will turn the battery 402 off and the blades will now be in a safe position. Not shown are motor brakes and other details to assure that the motor does not turn once power is removed by the feather limit switch 418.

In this example the safety loop must be closed (power applied) in order for K1 to be pulled in and to enable Servo Operation via commands from a Wind Turbine Controller 420. As with all conventional safety systems, any loss of power will cause K1 to drop out and a pitch system 400 to feather the blades using the battery 402 and the DC motor 416. This passes the international and regulatory requirements for a “fail safe” system to protect the turbine.

FIG. 5 shows the overview of a safety loop 500 and a number of safety relays 502 in each blade as well. A set of switches 504 and buttons 506 are wired in series and connected to the three emergency pitch relays 502 in each blade through a slip ring assembly 508 for transition to a hub. The logic for this system is simple: all switches must be closed to allow the turbine control system to control the blades under its command. Any switch that opens will open the safety loop and the blades will move to their “safe” position of 90 degrees pitch angle, i.e., feathered.

Also not shown in this drawing are any extra poles for these switches to allow for monitoring of the Safety System by the master controller so that an operator may determine, remotely, which of the safety switches is open and which is closed.

To increase safety, ensure protection of investment, and pass government safety requirements that vary among countries, wind turbines employ safety systems with various levels of robustness. However, the need arises to further provide wind turbine safety systems with a high level of intelligence to help protect the extensive investment that companies make in these increasingly complex and large industrial components and to help prevent any failure or potentially harmful consequences that may result from a control system failure of any type.

### SUMMARY

The following presents a simplified summary in order to provide a basic understanding of one or more aspects of the disclosure. This summary is not an extensive overview and is neither intended to identify key or critical elements, nor to delineate the scope thereof. Rather, the primary purpose of the summary is to present some concepts of the disclosure in a simplified form as a prelude to the more detailed description that is presented later.

A safety system in one embodiment of the disclosure provides an input/output module that is coupled to a protection safety master (PSM) controller and provides a status of various safety components. The input/output module and the PSM controller are separate from a turbine control unit in order to enable an added layer of safety to the turbine, rather than relying on the constant wellbeing of the turbine control unit alone. The PSM controller therefore functions to control fail-safe reactions, such as feathering of the blades or other reactions, by controlling a fail-safe circuit and storing and processing the logic for determining when a fail-safe reaction occurs.

In another embodiment, the PSM controller receives a status of safety components from various input/output modules located at different regions of a turbine tower. The PSM controller also receives a status of the input/output modules as well as a status of the turbine control unit for determining whether a fail-safe reaction occurs, which is also based on the status of the safety components received. The input/output modules comprise digital input modules that are located at various regions of a wind turbine tower, including up, down, and mid-regions, as well as at a nacelle region for monitoring safety throughout. The safety components are individually and separately connected to respective input/output modules, including sensors with single pole switch outputs, fail-safe devices, non-fail safe devices, emergency stop buttons, and/or logic devices and the like. The PSM controller controls the safety loop circuit comprising a pitch control unit having different relays that operate an emergency feathering reaction when the safety loop is open or power is removed from that loop.

In another embodiment, the fail-safe circuit is a wired circuit for a current to flow from the PSM controller through a latch and/or reset assembly to a pitch control unit. The safety components are connected in a wired connection to the input/output modules independently and separately from each other. In other words, each input/output module is connected to safety components, which are wired individually to each module without connection to one another. Based on their status (e.g., a failed status, operational status, an open or closed position, etc.), the safety components signal if an unsafe condition is present and indicate where in the tower the condition may be located.

In another embodiment, the PSM controller is connect to the input/output modules in a master/slave configuration. The input/output modules each have a slave processor and connect with one another in a daisy chain configuration. The PSM controller has a master processor that controls the slave processors of the input/output modules and is connected to the input/output modules via an optic conductor, such as a fiber optic cable or the like. The modules communicate the status of the safety components to the controller. The optic conductor is connected to the modules and PSM controller in a series configuration for transmitting communications in packets, for example. Additionally, the PSM controller also communicates via an optic conductor with the turbine control unit of the wind turbine. A status of the components and the safety system is provided to the turbine control unit for an operator to review, for example. The PSM receives communication from the turbine control unit to obtain a status of the turbine control unit, and the PSM maintains control of the safety loop circuit for initiating the fail-safe reaction.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 is a schematic view of an exemplary wind turbine safety system in accordance with an aspect of the present disclosure;

FIG. 2 illustrates an exemplary wind turbine safety system in accordance with another aspect of the present disclosure;

FIG. 3 illustrates an exemplary method for a safety system to monitor the safety of a wind turbine in accordance with still another aspect of the present disclosure;

FIG. 4 illustrates the pitch system and its emergency feather function; and

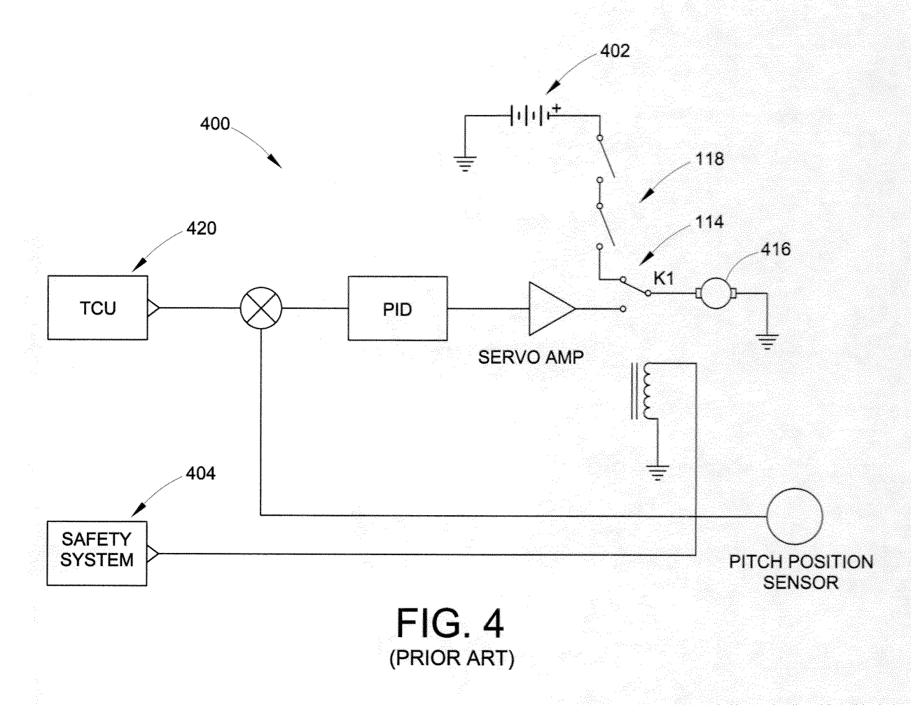

FIG. 5 illustrates a conventional (prior art) safety system used in a typical wind turbine application.

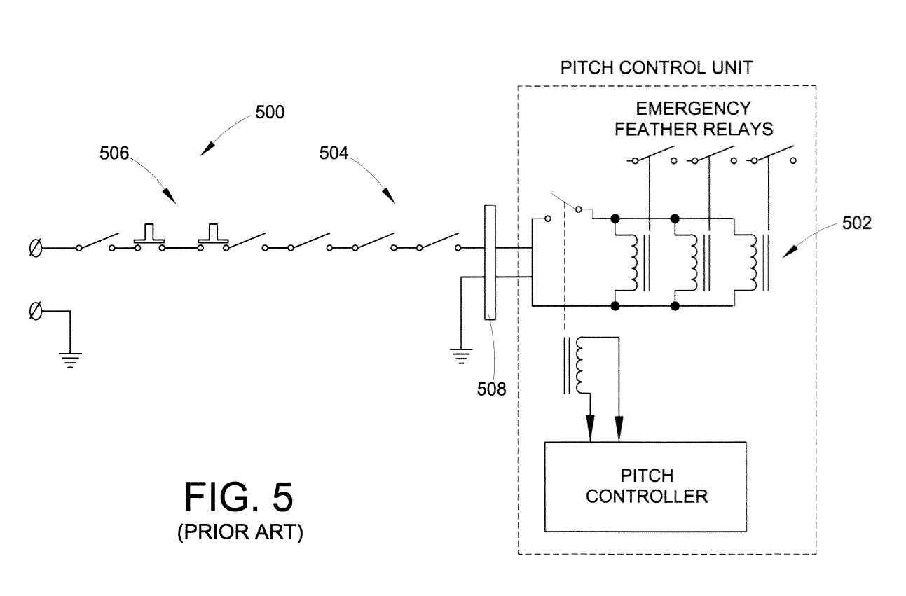

### DETAILED DESCRIPTION

One or more implementations of the present disclosure will now be described with reference to the attached drawings, wherein like reference numerals are used to refer to like elements throughout.

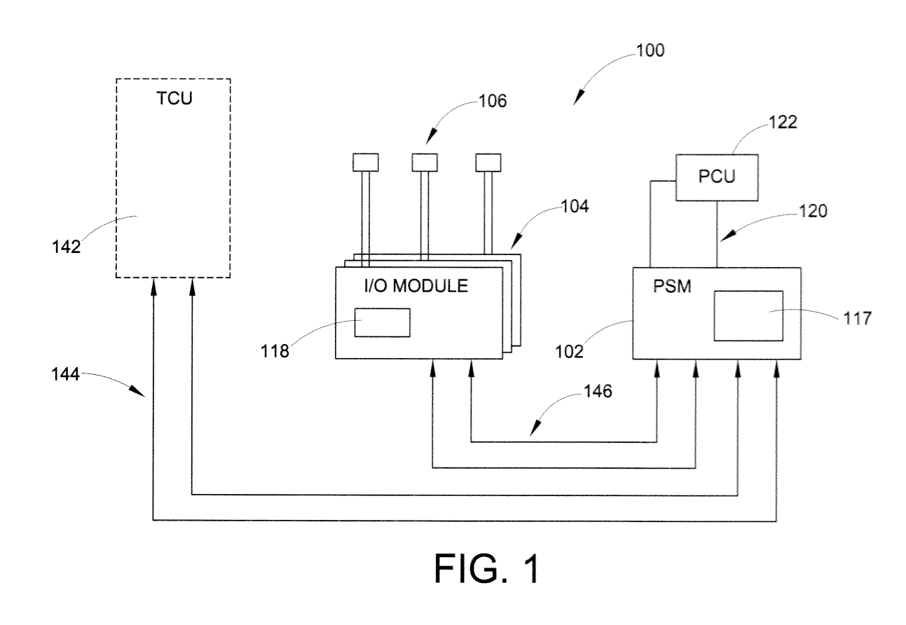

FIG. 1 illustrates an exemplary embodiment of a safety system 100 for a wind turbine having a plurality of blades (not shown). The safety system 100 comprises a protection system master (PSM) controller 102 having a master processor 117 for providing an independent, distributed, protection and safety control system. The system 100 includes one or more input/output modules 104 with slave processors 118 that provide input and output connections for a plurality of safety components 106 of the system 100 and monitor the status of each of the components 106. The protection system master (PSM) controller 102 is independent of a turbine control unit (TCU) 142, which generally monitors and controls data relevant for securing and operating the wind turbine. Such an independent PSM controller, for example, provides an additional layer of safety and independently controls of a safety loop circuit 120 of the safety system 100 that has a pitch control unit (PCU) 122 coupled therein. The safety components 106 are monitored by each input/output module 104 and the status of each component 106 is reported to the PSM controller 102 via fiber optic conductors 146 to determine whether a fail-safe reaction (e.g., a feathering of the rotor blades) should be initiated. A fail-safe reaction instigates the opening of the safety loop 120 by removing the current being supplied by the output portion of the PSM module 102, which allows the three Emergency Feather Relays, 136, 138, & 142, in the Pitch Control Unit 122 to drop out and this causes an Emergency Feather Condition. A turbine control unit link 144 enables the PSM controller 102 to communicate its status and fail-safe operation to the overall wind turbine master control unit 142.

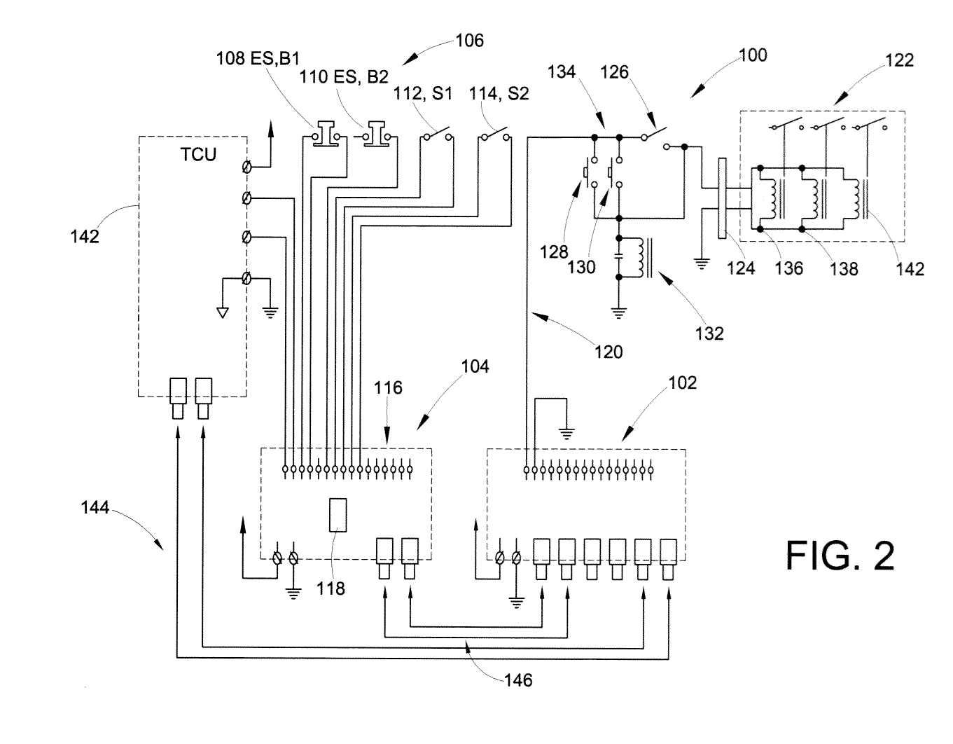

Referring now to FIG. 2, the exemplary safety system 100 is shown in greater detail. Safety components 106 are configured into the fail-safe circuit for monitoring the overall health of the turbine. The PSM controller 102 has independent control over the safety system 100 and monitors the status of the entire turbine system. For example, the PSM controller 102 receives a status of the safety components 106, a status of input/output board modules 104 connecting the safety components 106, and also a status of the TCU 142. In return because of the two way communication shown between the TCU 142 and the PSM 102, the turbine control unit also receives a status update from the safety system for re-transmit and display to the turbine operators. Providing an independent system that controls and determines when a fail-safe reaction occurs achieves a higher level of protection and safety redundancy while reducing the number of inputs the TCU is required to monitor. In one embodiment, the system 100 comprises the plurality of input/output modules 104 distributed along the tower at upper, lower and mid-regions (not shown) thereof with the safety components 106 respectively coupled thereto.

The safety components 106 include various safety devices, buttons, sensors, switches and/or logic devices. For example, the safety components 106 may comprise at least one of a single pole switch, a double pole switch (not shown), an emergency stop button, a fail-safe switch (not shown), a non-fail safe switch and a logic device (not shown). Safety components 108 and 110, for example, include emergency stop buttons (ESB1, ESB2). Safety component 112 includes an independent overspeed switch (S1), for example, and safety component 114 includes an excess vibration mechanism switch (S2). The safety components 106 are not limited to the examples illustrated herein and other safety components are also envisioned as within the scope of this disclosure. For example, logic devices, gates and/or arrays are also operable for providing complex devices that are configured as safety components for monitoring safety of the wind turbine. Certain fail-safe devices can be implemented within the system 100 and coupled to the input/output module 104 for increasing safety and protection of the windmill turbine in various environments. The safety components 106 illustrated comprise single pole devices, such as switches with one input and output connection coupled to the input/output module 104. Double poled switches and non-fail safe devices can also be included in the safety components 106 and are within the scope of this disclosure. The use of a double pole switch, as the output of a sensor, for example, could provide a higher level of safety than a single pole switch in that the status of that switch can be monitored, especially if that switch is a rated “safety relay” where the contacts are guided. This may be more needed as the safety level of the overall safety system increases due to requirements for personal or machine protection or both.

In one embodiment, the safety components 106 are connected to the input/output module 104 independently and separately from one another. For example, safety components 108, 110, 112, and/or 114 are connected to the input/output module 104 with a wired connection (e.g., a copper or other type wired connection). Each safety component typically includes input/output connections 116 that directly connect to the input/output module 104 without additional connections directly coupling the components to one another or other components of the system.

The input/output module 104 includes a digital input module, such as a DIN board, for example, that has a microcontroller 118. The input/output module 104 is operable as a slave controller in a master/slave configuration to the PSM controller 102. In one embodiment, multiple input/output modules are, therefore, coupled to together in a daisy chain configuration for communication with and control by the PSM controller 102. The input/output module 104 monitors a status of each safety component, such as on an individual basis with the safety components 106. For example, a status of a safety component may include a failed or operational status, where a failed status indicates that a non-safe condition may be present and an operational status indicates a safe condition present. More complex levels of status are included where, for example, complex devices, such as fail-safe switches or logic devices are incorporated for monitoring a condition of the wind turbine. A status of a safety component may be an intermediate level of danger, a high level of danger, a low level or of no concern, for example. In one embodiment, weighted levels of failure can be provided to the PSM controller for certain safety components or logic devices that may have programmed instructions, such as Bayesian recursive estimations or artificial intelligence networking therein, for example. Other various safety component designs and levels of status associated therewith are also within the present scope of this disclosure, as one of ordinary skill in the art can appreciate.

The PSM controller 102 provides an independent embedded control system that gathers through a fiber communication system, safety related component and tachometer data to generate an output for a safety loop circuit 120, which controls the Emergency Feather Relays (136, 138 and 142) within the Pitch Control Unit 122 to initiate an Emergency Feather Command and place the turbine into a safe operation position and shut down. The PSM controller 102 is configured to independently receive status information regarding the health of the wind turbine and determine whether the system needs a fail-safe reaction, such as initiating an emergency feathering of the blades. The PSM controller 102 is an independent master controller with a master processor that monitors the health of the safety components by receiving their status from each input/output module 104. The PSM controller 102 selectively controls the input/output modules via a master/slave configuration, as discussed above. In this manner, multiple input/output modules are distributed throughout the wind turbine tower (not shown) with safety components coupled thereto and the location of any one input/output module is not restricted.

The PSM controller 102 is coupled to and controls the operation of the safety system 100 by controlling the current with the safety loop circuit 120 for initiating the fail-safe reaction. This circuit is fail-safe because its output is turned on during period when no fault or improper safety loop operation is detected. Any sensor that opens or signal that initiates an emergency feather of the wind turbine will be tracked by the PSM 102, which, in turn, opens its output and the current through the safety loop circuit 120 will drop to zero. In addition, if the wire between the PSM 102 and the safety components in the Pitch Controller opens due to a misconnection or a wire that is cut for some reason the same reaction will occur and the turbine will make an emergency feather operation to 90 degrees, a safe operating position. In one embodiment, the fail-safe circuit 120 includes the PSM controller 102, a pitch control unit (PU) 122 for feathering of wind turbine blades (not shown), and a slip ring assembly 124 for providing power to the PCU 122. The fail-safe circuit 120 further includes a latch and reset assembly 126 having a series of reset switches 128 and 130 located in various locations within the nacelle and used to reset the safety loop 134 after maintenance or troubleshooting by a technician. The coil of this relay is connected to the source of its DC supply current by the safety loop 134. Once this source of current is disabled the relay drops out the turbine feathers to its 90 degree position. The circuit remains open due to the contacts 126 of the relay 132. Once current is restored by the PSM 102, the safety loop is restored by pressing any of the reset buttons, which allow current to flow back into the relay coil and the contacts close completing the safety loop circuit. This latching relay connection is used to prevent intermediate connection problems with the output of the PWM 102, but may or may not be required by local and government policy boards and international standards. Further, the PCU 122 of the safety loop circuit 120 includes relay devices 136, 138, and 140, for example, which are feather the blades of the turbine with power or current that is removed from their coils. The safety loop circuit 120, as illustrated, includes wired connections coupling the PCU 122. Once the PSM controller 102 determines that an emergency feather control action should occur, a current or electrical signal from the PSM controller is interrupted and the relays on all three axis of the pitch system drop out which forces an emergency feather action at the hub of the turbine.

The PSM controller 102 couples the safety system 100 to a turbine control unit (TCU) 142 of the wind turbine via a turbine communication link that is an optic conductor 144, such as a fiber optic cable or the like, for example. The PSM controller 102 also receives a status or wellbeing state of the TCU 142 to factor into the decision processes for initiating a safety or fail-safe reaction, such as by the TCU's watchdog outputs. The TCU 142 generally monitors and controls data throughout the wind turbine. However, the logic for initiating and controlling fail-safe reactions is governed by the PCM controller 102 with master control of the safety system. The TCU, for example, is coupled to the PSM controller 102 in a series configuration in FIG. 1, which enables a single pair of transmit and receive connections therebetween. The TCU 142 receives status information of the safety system 100 and of the various safety components 106 of the wind turbine via the PSM controller 102. The status can then be reported to an external display (not shown) or some other means for informing an operator of the status. The TCU 142 is also able to request status information and also trigger the PSM controller 102 to initiate the fail-safe reaction to feather the blades, for example, via the connection 144. However, the PSM controller maintains and controls the safety system 100 of the turbine.

The PSM controller 102 of the safety system 100 also connects to the input/output module 104 via fiber optic communication conductors 146. The input/output module 104 is a separate assembly from the TCU 142, and thus, the TCU 142 of the wind turbine has fewer inputs to monitor directly, which also results in less input/output modules or digital input boards in the turbine. Communication via the optic conductor 146 can be signaled in a communication packet. The PSM controller 102 thus receives status information for the safety devices 106 via their connection to the input/output module 104 and then through the fiber optic communication conductors 146, which are configured in a single serial connection between the controller and the input/output module which has transmit and receive connections. In addition, the communication packet sent by the input/output module provides the status of the input/output module 104 to the PSM controller 102, which can respond accordingly if one or more of the modules is failing or has failed in addition to any of the 106 safety devices signaling an unsafe condition.

In one embodiment the PSM controller 102 observes the status of the switch inputs and sensor inputs on the input/output module 104 through the fiber optic communication channel 146. Since all of these switch inputs are fail safe, they are closed when there is no fault or failure condition based on their specific monitor and design. If any single switch opens that status is signaled to the PSM 102 module through the communication channel 146 from the input/output module 104. When this occurs the PSM 102 module then determines the safety reaction or fail-safe reaction based on the status of the internal and programmable logic within the PSM 102 microprocessor itself. In this manner, the safety components 106 do not need to be wired into the safety loop circuit 120 directly, such as in a wired series connected loop, for example, but instead are coupled into the safety loop circuit 120 by the logic of the PSM controller 102. The logic with control 102 may be designed so that multiple fail safe switches or sensors need to be open (failed) in order to generate an Emergency Feather Command or EFC. Under these circumstances, for example, the opening of one switch may not indicate a high enough level of failure to require the PSM controller 102 to open the safety loop circuit and initiate a fail-safe reaction, such as by feathering the wind turbine blades. However, the status of the safety component may be high enough to require that the PSM controller 102 communicate this finding to the TCU 142 over a second set of fiber optic communication cables or an optic conductor connection 144. The TCU in that case may have logic that will shut down the turbine in a “normal” fashion instead of through an EFC reducing the loads on the turbine for this particular shut down. Alternatively, the safety components may also be configured directly as in a series connected loop into the safety loop 120, depending upon the logic of the PSM controller 102.

In one embodiment, the PSM controller 102 determines the status of the safety loop 120 by determining if the sensors and switches reporting to the input/output module 104 are opened, since these are fail safe switches and sensors that fail in an open circuit condition. In some instances, as discussed above, a single switch may not be enough to initiate any fail-safe reaction. However, once a certain combination or predetermined threshold of failures has occurred as determined by the PSM controller 102, the safety loop 120 current will be switched to zero and an EFC will result. For example, the PSM controller 102 may initiate a fail-safe reaction based on at least one predetermined combination of safety components having a failed status. The status of the input/output modules 104 and the TCU 142 may also be taken into consideration as part of this predetermined combination having a failed status to indicate that the fail-safe reaction should be initiated.

In another embodiment, the optic conductor connections 144 and 146, as discussed above, are paired in one example to make up a serial communication connection for sending data to and from remote and/or local input/output modules 104 operating as slave modules to the PSM controller 102. This provides the safety system 100 an added flexibility for being implemented into various wind turbines. For example, the signals that remote slave modules receive may not or may be direct fail-safe signals depending upon the logic for the safety loop circuit 120 within the PSM controller 102.

In another embodiment, the output of the PSM module 102 may have two or more safety loops for initiating a more complex and intelligence Emergency Feather shut down depending upon the loading requirements of the turbine during these special events. In that case there would be at least two Safety Loops like the one shown in 120 and two different Emergency Feather Relay groups to initiate two different blade feathering rates as an example.

The safety system 100 thus provides several advantages. For example, few wires are required for connection between the safety components 106, such as safety related switches and the safety loop 120. A higher integrity level is provided to wind turbine due to independent monitoring of each safety component signal within the safety system by a processor that is dedicated to this process and not burdened with expending resources for other duties. Additionally, the safety system 100 provides a distributed system so that placement of necessary controls can be easily done anywhere in a turbine, such as in the down tower, up tower and mid-tower, or any region thereat, without concerns for interference and/or nuisance faults resulting. As a result, certification agencies may more quickly certify and grant approval to the system 100.

Further advantages are provided by the system 100, in that no independent overspeed relay is necessary since the PSM controller 102 is capable of handling this function internally. Operators of the wind turbine can also perform internal diagnostic testing on the safety system without causing an EFC, thereby putting less stress and fatigue on the turbine during commissioning. Furthermore, input/output requirements of the TCU 142 are less, which provide a less burden therein.

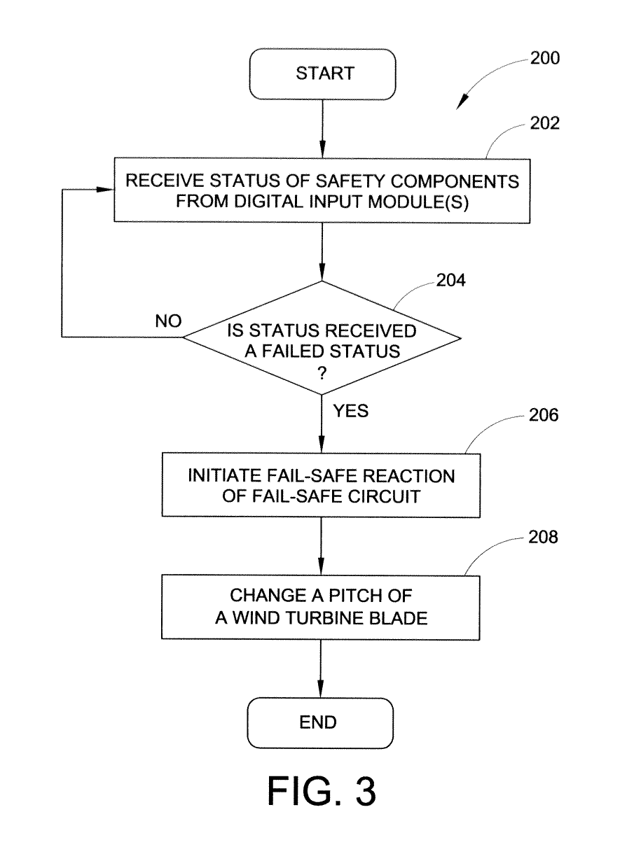

With reference now to FIG. 3, an example methodology 200 to monitor safety and to initiate a fail-safe reaction for a wind turbine safety system is there illustrated. While the method is illustrated and described below as a series of acts or events, it will be appreciated that the illustrated ordering of such acts or events is not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 200 initiates at start, and at 202 a status of safety components 106 is communicated via a first communication pathway 146 from one or more separate digital input modules 104 with a slave processor 118 to a protection safety master (PSM) controller 102. Each slave processor 118 of the digital input modules 104 monitors a status of the safety components 106, and thus, transmits the status of each safety component 106 to the PSM controller 102. In one embodiment, the first communication pathway 146 includes an optic conductor for transmitting interference free signals between the PSM controller 102 and the digital input modules 104 of the system 100, such as with communication packets or the like.

At 204, the PSM controller 102 gathers data and determines whether a fail-safe reaction should be signalled by the PSM controller. The decision to initiate the fail-safe reaction is based on a status of a predetermined combination of the safety components 106, and the status of the input/output module 104 as well. If the PSM controller 102 does not determine that the status is a failed status, the decision cycles back to 202 where the PSM controller 102 continues to receive status information regarding the safety components form digital input modules 104. The cycle time for this monitoring is usually in real time, but based on the output bandwidth of the sensors connected at 106, it may actually be slower or ignored for several communication channels to remove noise and nuisance fault conditions. Alternatively, one or more safety components, which may be fail-safe switches or non-fail-safe switches, having a failed status could cause the PSM controller 102 to initiate a fail-safe reaction (e.g., an emergency feathering of the rotor blades).

In one embodiment, the PSM controller 102 is capable of making a decision to initiate the fail-safe reaction based on any data that it receives including the status of each safety component 106 along with the status of the digital input modules 104 own health, and/or a status of the turbine control unit 142, for example. When a safety component is a logical device or switch, for example, that employs more than one device with a failed status, the PSM controller 102 may determine that the wind turbine is still capable of functioning without the need to initiate the fail-safe reaction. The status of the safety component, however, may be transmitted to the turbine control unit via a turbine control unit link 144 or optic conductor for reporting to an operator of the wind turbine, such as at a display interface, for example.

At 206, the PSM controller initiates the fail-safe reaction by opening the safety loop 120 upon determining that at least one predetermined combination of safety components has a failed status. In one embodiment, at 208, the pitch of the wind turbine blades may be changed.

In another embodiment, the safety components 106 comprise at least one of a single pole switch, a double pole switch, an emergency stop button, a fail-safe switch, and a logic device connected to the one or more digital input modules independently and separately of one another in a wired connection.

Although the disclosure has been shown and described with respect to one or more implementations, equivalent alterations and modifications will occur to others skilled in the art upon the reading and understanding of this specification and the annexed drawings. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art. It is intended to include all such modifications, variations or improvements insofar as they come within the scope of the appended claims or the equivalents thereof.

What is claimed is:

1. A safety system for an energy producing device comprising:
an input/output module connected to one or more safety components that determines a status of each of the one or more safety components for a safety reaction of the energy producing device;
a protection system master (PSM) controller coupled to the input/output module that monitors the status of the safety components, including a master processor that is configured to couple each of the one or more safety components into a safety loop circuit that is fail-safe and initiates an Emergency Feather Shutdown of the device; and
a control unit of the associated energy producing device, wherein the PSM controller includes a control communication link that provides a status of the safety loop circuit to the control unit.

2. The safety system of claim 1, wherein the device comprises a wind turbine including a plurality of blades.

3. The safety system of claim 2, wherein the safety components comprise at least one of a single pole switch, a double pole switch, an emergency stop button, a fail-safe switch, a non-fail safe switch, a sensor, and a logic device that are connected to the input/output module independently of one another, and the status of the safety devices includes a failure status and/or an operational status that is provided to the turbine control unit from the input/output module to the PSM controller via the communication link.

4. The safety system of claim 2, wherein the PSM controller is communicatively coupled to the input/output module via an optic conductor for monitoring a status of the safety loop circuit and a status of the input/output module.

5. The safety system of claim 2, wherein the safety components are independently connected to the input/output module via a wired connection, and the input/output module is a digital input board.

6. The safety system of claim 2, wherein the control communication link comprises an optic conductor for the PSM controller to communicate to the control unit of the wind turbine the status of the safety loop circuit and the status of each of the safety components.

7. The safety system of claim 2, wherein the system processor of the PSM controller is configured to connect each safety component in the safety loop circuit in a series connection or logic connects via programmable logic therein and to initiate the safety reaction in response to the status of the safety loop circuit by feathering the blades to a safe 90 degree position.

8. The safety system of claim 2, wherein the safety loop circuit comprises:
a pitch control unit having relays for controlling the safety reaction that includes a change of pitch in the wind turbine;
a slip ring assembly that provides an electrical connection from the PSM controller to the pitch control unit for transmitting power thereto; and
wherein the PSM controller connects each safety component to the safety loop circuit in a series connection with programmable instructions and initiates the safety reaction in response to the status of the safety loop circuit exceeding a predetermined threshold.

9. The safety system of claim 2, wherein the input/output module does not communicate directly with the control unit.

10. The safety system of claim 6, wherein the turbine control unit only communicates with the PSM controller.

11. A fiber optic safety system for an energy producing device comprising:
a plurality of digital input modules located at different vertical regions of an associated tower, each module comprising at least one slave processor configured to monitor safety components that are independently and separately connected to the digital input module, the at least one slave processor determining a status of each of the safety components;
a protection safety master (PSM) controller including a master processor that controls each slave processor and is configured to receive the status of the safety components from the plurality of digital input modules and to control a safety loop circuit for initiating a fail-safe reaction to be taken by the energy producing device based on the status of the safety components.

12. The system of claim 11, wherein the energy producing device comprises a wind turbine including a plurality of blades.

13. The system of claim 12, wherein the PSM controller comprises a turbine unit serial connection having an optic conductor that couples the PSM controller to a turbine control unit for receiving a status of the control unit and for transmitting a status of the safety loop circuit and safety components.

14. The system of claim 12, wherein the plurality of digital input modules are coupled to the PSM controller via an optic conductor and in a daisy chain configuration to one another, and the safety components are connected to the digital input modules via a wired conductor.

15. The system of claim 12, wherein the safety loop circuit comprises:
a pitch control unit that controls pitch of wind turbine blades in response to the PSM controller initiating the fail-safe reaction; and
wherein the PSM controller is coupled to the pitch control unit and configured to couple the safety components into the safety loop circuit via executable software instructions and to initiate the fail-safe reaction based on at least one predetermined combination of safety components having a fail status.

16. The system of claim 15, wherein the safety loop circuit further comprises:
a slip ring assembly for transmitting power to the pitch control unit; and
a safety loop latch and reset mechanism;
wherein the PSM is configured to initiate the fail-safe reaction further based on the status of the digital input board and the status of the turbine control unit.

17. A method of monitoring safety and initiating a fail-safe reaction in an energy producing device having a safety loop circuit, the method comprising:
communicating a status of safety components via a first communication pathway from one or more separate digital input modules to a protection safety master (PSM) controller;
determining whether a fail-safe reaction should be signalled by the PSM controller based on the status of a predetermined combination of the safety components;
upon the PSM controller determining that at least one predetermined combination of safety components has a failed status, initiating the fail-safe reaction of the safety loop circuit connected to the PSM controller via a second communication pathway from the PSM controller.

18. The method of claim 17, wherein the energy producing device is a wind turbine including a plurality of blades.

19. The method of claim 18, further comprising:
communicating a status of each digital input module and a status of a turbine control unit to the PSM controller, and
determining whether a fail-safe reaction should be signalled by the PSM controller based on the status of each digital input module, the status of the turbine control unit and/or the status of each safety component.

20. The method of claim 18, wherein communicating via the first communication pathway includes sending a communication packet to the PSM controller via the first communication pathway having an optic conductor.

21. The method of claim 18, wherein the safety components comprise at least one of a single pole switch, a double pole switch, an emergency stop button, a fail-safe switch, and a logic device connected to the one or more digital input modules independently and separately of one another in a wired connection.

22. The method of claim 18, wherein the status of the safety components includes a failed status or an operational status that is provided to the PSM controller via an optic conductor to determine whether a fail-safe reaction should be initiated, and that is provided to a turbine control unit from the PSM controller via a turbine control communication link having an optic conductor.

23. The method of claim 18, wherein initiating the fail-safe reaction comprises sending an electrical signal via the second communication pathway having a wired connection to a pitch control unit that activates relays and changes a pitch of wind turbine blades.
